(19) United States
(12) Patent Application Publication
(10) Pub. No.: US 2009/0154051 A1
(43) Pub. Date: Jun. 18, 2009

(54) Device for Connecting Two Points in an Electric Circuit

(76) Inventor: Josep Montanya Silvestre, Rubi(Barcelona) (ES)

Correspondence Address: STAAS & HALSEY LLP, SUITE 700, 1201 NEW YORK AVENUE, N.W., WASHINGTON, DC, 20005, US

(21) Appl. No.: 12/085,441

(22) PCT Filed: Nov. 23, 2006
(86) PCT No.: PCT/EP2006/011234

§ 371 Date: May 23, 2008

(30) Foreign Application Priority Data
Nov. 25, 2005 (ES) 200502916

(51) Int. Cl. H01H 47/00

(52) U.S. Cl. 361/211

(57) ABSTRACT

Device for connecting two points in an electrical circuit. The device acts externally like an individual relay, but includes a first micro electro-mechanical systems (“MEMS”) relay and at least a second MEMS relay. Each relay has four condenser plates and a conducting element movably housed inside the relay, opening and closing a circuit, by applying certain control signals to the condenser plates. The second relay can be connected to one of the plates of the first relay, to create a high impedance in the plate, or it can be connected serially or in parallel to the first relay but controlled with different control signals, whereby the operational range of the first relay and, therefore, that of the overall device, is extended.

### FIELD OF THE INVENTION

The invention relates to a device for connecting two points in an electric circuit, that comprises: [a] a first miniaturized relay, where the first miniaturized relay comprises: [a1] an intermediate hollow space that defines a first end and a second end, which is opposite the first end, [a.2] a conducting element housed inside the intermediate space and which is a loose part that can move between the first end and the second end of the intermediate space, [a.3] a first condenser plate and a second condenser plate arranged next to the first end, [a.4] a third condenser plate and a fourth condenser plate arranged next to the second end and opposite the first condenser plate and the second condenser plate, where the conducting element moves between the first end and the second end according to electrical signals applied to the condenser plates, [a.5] two contact points, where the conducting element is suitable for contacting with both contact points, joining them electrically, [b] a control circuit, where the control circuit acts upon the first miniaturized relay by applying to at least one of the first, second, third and fourth condenser plates of the first miniaturized relay a first control signal and by applying to at least another of the first, second, third and fourth condenser plate of the first miniaturized relay a second control signal, where the second control signal is smaller than the first control signal.

### STATE OF THE ART

Devices are known like those indicated above. In fact, usually, the device is made up of a single relay that performs the function of connecting and disconnecting two points in an external circuit. The above-mentioned relays are described, for example, in PCT application WO2004046019, published on 3 Jun. 2004, and in the name of the same applicant. These miniaturized relays are made using specific methods for making micromechanisms, known as MEMS (micro electro-mechanical systems), Microsystems y/o Micromachines. PCT application WO2004046019 describes in detail the operation of these relays and also describes multiple designs with various improvements. In particular, pages 3 and 4 describe the relay, its operation and the advantages thereof over other relays, page 6, line 16 to page 8 line 15 describes in detail a relay with 4 or more condenser plates, page 10 line 24-30 describes a relay that acts simultaneously on two external circuits in a complementary form (opening one when the other closes, and vice versa), page 19 line 7 to page 22 line 2 (together with FIGS. 1-3) details the operation, and page 22 line 4 to page 23 line 3 (together with FIGS. 4 and 5) details the geometry of a miniaturized relay (MEMS relay).

However, since these miniaturized relays have a conducting element responsible for opening and closing an external circuit that is a loose part and is moved thanks to electrostatic forces, they suffer from some drawbacks. For example, in certain working conditions, it cannot be guaranteed that the relay opens or closes the external electrical circuit.

Therefore there is the need to develop a new device for connecting two points in an electrical circuit which, comprising a miniaturized relay like the one indicated, has a more versatile operation.

Hereinafter, in this specification and claims, whenever reference is made to a relay, it will refer to a miniaturized relay like those indicated above (in other words, like those described in PCT application WO2004046019) unless expressly indicated otherwise. Both the analyzed problem and the proposed solutions are specific for this type of relays.

### DISCLOSURE OF THE INVENTION

This object of this invention is a device for connecting two points in an electrical circuit of the type indicated at the beginning, characterized in that [1] it comprises, in addition, [c] a second miniaturized relay, where the second miniaturized relay comprises: [c1] an intermediate hollow space defining a first end and a second end, which is opposite the first end, [c.2] a conducting element housed inside the intermediate space and which is a loose part that can move between the first end and the second end of the intermediate space, [c.3] a first condenser plate and a second condenser plate arranged next to the first end, [c.4] a third condenser plate and a fourth condenser plate arranged next to the second end and opposite the first condenser plate and the second condenser plate, where the conducting element moves between the first end and the second end according to electrical signals applied to the condenser plates, [c.5] two contact points, where the conducting element is suitable for contacting with both contact points joining them electrically,

and in that
[2] either the second relay has one of its contact points connected to one of the first, second, third and fourth condenser plates of the first miniaturized relay, whereby when the second miniaturized relay is open, the condenser plate of the first miniaturized relay that is electrically connected to one of the contact points of the second miniaturized relay remains in a state of high impedance;
[2′] or the second miniaturized relay has at least one of its contact points connected to one of the contact points of the first miniaturized relay, and [3′] the control circuit acts on the second miniaturized relay by applying to at least one of the first, second, third and fourth condenser plates of the second miniaturized relay a third control signal and by applying to at least another of the first, second, third and fourth condenser plates of the second relay a fourth control signal, where the fourth control signal is larger than the third control signal, whereby the second relay is activated with its polarity inverted with respect to the first miniaturized relay, where none of the first, second, third and fourth condenser plates of none of the first and second miniaturized relays remain in a state of high impedance;
[2″] or the second miniaturized relay has at least one of its contact points connected to one of the contact points of the first miniaturized relay, and [3″] the control circuit acts upon the second miniaturized relay by applying to at least one of the first, second, third and fourth condenser plates of the second miniaturized relay a third control signal and by applying to at least another of the first, second, third and fourth condenser plates of the second relay a fourth control signal, where the fourth control signal is smaller than the third control signal, whereby the second relay is activated with the same polarity as the first relay, where at least one of the third and fourth control signals is different from the first control signal and the second control signal, where none of the first, second, third and fourth condenser plates of none of the first and second miniaturized relays remains in a state of high impedance.

The third signal is equivalent to the first signal and the fourth signal is equivalent to the second signal, so that if the third signal is larger than the fourth signal the second relay has its polarity in the same direction as the first relay, whereas if the third signal is smaller than the fourth signal then the second relay is polarized in reverse direction with respect to the first relay. Below the concept of a relay with inverted polarity is explained.

The device according to the invention acts, from the point of view of the user, as if it was a single relay, in other words, it is a device that is used to open or close an external circuit. However, inside the device there are two or more relays whose function is not to open and close other external circuits but to extend the working range (the operational range) of the device.

### BRIEF DESCRIPTION OF THE DRAWINGS

Other advantages and characteristics of the invention are appreciated from the following description, in which, with a non-limiting character, describes preferred embodiments of the invention, with reference to the accompanying drawings. The figures show:

FIG. 1, a layout of a miniaturized relay of a device for connecting an electrical circuit according to the invention.

FIGS. 2 through 6, various connection layouts of two relays according to the alternative 1 of the invention,

FIG. 7, the equivalent electrical circuit when the conducting element is not connected to the contact points of the external circuit,

FIGS. 8.1, 8.2 and 8.3, graphical representations of the function Fₑ(V_{S}) for cases 1, 2 and 3.

FIGS. 9.1 and 9.2, graphical representations of the function Fₑ(V_{S}) for case 3 with direct and inverted polarity.

FIGS. 10.1 and 10.2, electrical layouts of two relays with inverted polarity with respect to one another,

FIG. 11, a graphical representation of the function Fₑ(V_{S}) for a device according to the invention.

FIG. 12, a layout of a first device according to the invention.

FIG. 13, a layout of a second device according to the invention.

FIG. 14, a layout of a third device according to the invention.

FIG. 15, an electrical layout of alternative 1 of the invention, with the external circuit of the second miniaturized relay closed.

FIG. 16, a simplified version of the electrical layout in FIG. 15.

FIG. 17, a simplified version of the electrical layout in FIG. 16.

FIG. 18, an electrical layout of alternative 1 of the invention, with the external circuit of the second miniaturized relay open.

FIG. 19, a simplified version of the electrical layout in FIG. 18.

FIG. 20, the electrical layout in FIG. 17, taking into account the substrate resistances.

FIG. 21, the electrical layout in FIG. 20, simplified for when the time is very long.

### DETAILED DESCRIPTION OF SOME EMBODIMENTS OF THE INVENTION

The applicant has analyzed the various working conditions of the above-mentioned miniaturized relays, and has analyzed in what conditions the opening or closing of the external electrical circuit can fail, and has reached the following conclusions:

The miniaturized relay according to the invention works thanks to the fact that between the condenser plates and the conducting element electrostatic forces are produced that can move the conducting element in the desired direction. However, when the conducting element is in contact with the external electrical circuit, the conducting element is subjected to a voltage that is obliged by the external electrical circuit. This voltage can be known, for example in the event that the external electrical circuit is at the unit's supply voltage, V₀, or in the event that the external electrical circuit is directly connected to mass or ground. However, in other cases, the voltage Vₛ which the conducting element will have is a voltage that cannot always be known when designing the relay. But this voltage Vₛ affects the electrostatic force that the conducting element experiences, whereby the relay will only be able to open and close for certain Vₛ values, in other words, the relay will have a limited operational range. In order to be able to offer a device that can guarantee connection and disconnection within an operational range that is greater than the relay's operational range, suitable means must be included in the device to guarantee opening and closing the external electrical circuit according to a wider range of voltages than the voltage range of the loose relay.

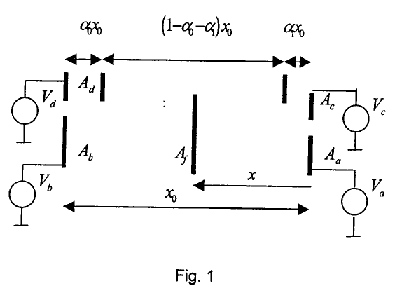

Generally, a miniaturized relay like the ones used for the connection device according to the invention has a structure like the one reflected diagrammatically in FIG. 1. The relay has a first condenser plate Aₐ and a second condenser plate A_{c} that are at a first end (to the right in FIG. 1) of the intermediate space, and a third condenser plate A_{b} and a fourth condenser plate A_{d} that are at the second end (to the left in FIG. 1) of the intermediate space and which are opposite the first and second condenser plates. Next to the fourth condenser plate A_{d} a contact point of the external circuit has been illustrated diagrammatically, placed at a distance α₀x₀. In fact, underneath this contact point, next to the third condenser plate A_{b}, there should be another contact point, not shown in the interest of clarity in the figures. For its part, next to the second condenser plate A_{c} a stopper has been illustrated diagrammatically, placed at a distance α₁x₀. As in the case of the contact points, in fact, underneath this stopper, next to the first condenser plate Aₐ, there should be another stopper, not shown in the interest of clarity in the figures. In fact, the real designs are two-dimensional and have more complex geometries, that can have various contact points and/or various physical stoppers, although they could be grouped together conceptually since they perform the same basic functions. Therefore, these diagrams/layouts must only be taken into account on a conceptual level. Between the stoppers and the contact points there is a conducting element A_{f}, which is a loose part that can move freely between the stoppers and the contact points.

In the following formulae, the references Aₐ, A_{b}, A_{c} y A_{d} have been used to designate the corresponding areas of the condenser plates, and, similarly, A_{f} represents the area of the mobile conducting element. The two contact points to the left are the ones that the conducting element will link electrically, and the two stoppers to the right are the ones preventing the conducting element from coming into contact with the condenser plates.

The electrostatic force Fₑ action upon the conducting element when this is moving without touching any contact point, is shown by the following equation:

$${F}_{e} = \frac{ɛ {V}_{0}^{2} {AC}_{AR}}{2 {x}^{2}} \frac{{C}_{A 1} \{ {C}_{A 2} - {{C}_{A3} ( \frac{{x}_{0}}{x} - 1 )}^{2} - {[ ( \frac{{x}_{0}}{x} - 1 ) {C}_{A 3} + {C}_{A 2} ]}^{2} \}}{{[ ( \frac{{x}_{0}}{x} - 1 ) ( {C}_{A 3} + 1 ) + {C}_{A 2} ]}^{2}}$$

where the values of the area coefficients C_{A2} and C_{A3} are shown by

$$\{ \begin{matrix}{C}_{A 2} = \frac{{A}_{2}}{{A}_{1}} \\ {C}_{A 3} = \frac{{A}_{3}}{{A}_{1}}\end{matrix}$$

C_{A1} is shown by

$${C}_{A 1} = \{ \begin{matrix}\frac{1}{{C}_{A 2}} , & {C}_{A 2} > {C}_{A 3} + 1 \\ \frac{1}{{C}_{A 3} + 1} , & {C}_{A 2} \leq {C}_{A 3} + 1\end{matrix}$$

x₀ is the distance between the condenser plates,
(1-α₀-α₀)x₀ is the distance between the contact points and the stoppers, in other words, it is the distance that the conducting element can cover along the intermediate space,
x is the position of the conducting element, where the origin is on the condenser plates to the right, and the direction of the positive x values is to the left,
α₀x₀ is the distance between the contact points and the condenser plates to the left,
α₁x₀ is the distance between the stoppers and the condenser plates to the right,
A is the total area of the relay, which is approximately the area of the conducting element,
C_{AR} is a coefficient between 0 and 1 that indicates the relationship between the total area of relay (A) and the total area of the condenser plates (max(Aₐ+A_{c}, A_{b}+A_{d}))
and the values A₁, A₂ and A₃, are defined in Table 1, wherein Vₐ, V_{b}, V_{c} and V_{d} are the voltages applied to condenser plates Aₐ, A_{b}, A_{c} and A_{d}, respectively, and Z indicates a high impedance state.

TABLE 1

| Vₐ | V_{b} | V_{c} | V_{d} | A₁ | A₂ | A₃ |
|---|---|---|---|---|---|---|
| 0 | Z | V₀ | Z | Aₐ | 0 | A_{c} |
| 0 | V₀ | V₀ | Z | Aₐ | A_{b} | A_{c} |
| 0 | V₀ | V₀ | V₀ | Aₐ | A_{b} + A_{d} | A_{c} |
| 0 | V₀ | Z | V₀ | Aₐ | A_{b} + A_{d} | 0 |
| Z | V₀ | 0 | Z | A_{c} | A_{b} | 0 |
| Z | V₀ | 0 | V₀ | A_{c} | A_{b} + A_{d} | 0 |

Using any of the combinations shown in Table 1, the conducting element will move in the direction of the negative x values, in other words, to the right in FIG. 1. If the values Vₐ and V_{c} in Table 1 are exchanged with the values V_{b} and V_{d} and also the values Aₐ and A_{c} are exchanged with values A_{b} and A_{d} to calculate the values A₁, A₂ and A₃, then the conducting element will move towards the positive x values, in other words, to the left in FIG. 1. This is summarized in Table 2.

TABLE 2

| V′ₐ | V′_{b} | V′_{c} | V′_{d} | A′₁ | A′₂ | A′₃ |
|---|---|---|---|---|---|---|
| Z | 0 | Z | V₀ | A_{b} | 0 | A_{d} |
| V₀ | 0 | Z | V₀ | A_{b} | Aₐ | A_{d} |
| V₀ | 0 | V₀ | V₀ | A_{b} | Aₐ + A_{c} | A_{d} |
| V₀ | 0 | V₀ | Z | A_{b} | Aₐ + A_{c} | 0 |
| V₀ | Z | Z | 0 | A_{d} | Aₐ | 0 |
| V₀ | Z | V₀ | 0 | A_{d} | Aₐ + A_{c} | 0 |

In the same way, equivalent area coefficient values C′ᵢ can be defined.

In both Tables it has been indicated that the possible voltages to be applied are V₀ (supply voltage, usually 5V) or 0V (ground or mass). However, it must be understood that, generally the same result is obtained using any two voltages, providing that the voltage substituting V₀ is greater than the voltage substituting 0. To facilitate matters, hereinafter, “V₀” should be interpreted as any voltage (the “control signal” mentioned above) and “0” should be interpreted as any other voltage smaller than the one above (the “second control signal” mentioned above), unless otherwise specified.

This way, both Tables 1 and 2 indicate the conditions in which the miniaturized relay must work so that it moves in both directions. Generally, there are two big groups of relay working conditions. On the one hand, one of the alternatives ones can be chosen in which one of the condenser plates must be in a state of high impedance (any of the lines 1, 2, 4, 5 or 6 in Tables 1 and 2). Hereinafter we will call them all alternative 1 as they will be analyzed together. On the other hand the alternative in line 3 in Tables 1 and 2 can be chosen, in which none of the condenser plates is in a state of high impedance, and which hereinafter we will call alternative 2.

So that the miniaturized relay (and, therefore, the connection device) can guarantee opening and closing the external circuit irrespective of the voltage to which the conducting element is subjected, the device must have suitable means (the “means suitable for guaranteeing the opening and closing of the external electrical circuit according to any voltage to which the conducting element is subjected” mentioned above), which guarantee certain working conditions, which are detailed below.

### Alternative 1

In the event that alternative 1 is chosen it is important to guarantee that the corresponding condenser plate is really in a state of high impedance. It must be taken into account that the condenser plates will really be in a particular physical environment, and they will be connected to their corresponding control circuits in a certain way. Using conventional solid state technologies, it is not possible for the condenser plate to be in a state of high impedance (infinite impedance), whereby it will have finite impedance. According to the invention, one way that the condenser plate can really be in a state of high impedance, is by controlling the condenser plate in question using a second miniaturized relay. This second miniaturized relay does not need to be able to work with the conducting element at any voltage, whereby its conducting element will only work at a certain, predetermined voltage (V₀ or 0) since its function will be to connect the condenser plate of the first relay to V₀ or 0. Therefore, it can be designed directly so that it guarantees the opening and closing of “its” external circuit. Therefore, the condenser plate of the first relay which is being controlled by the second relay will have its state of high impedance provoked by the second relay in open position, which means a very efficient high impedance value. At the end of this description obtaining a state of high impedance in the plates of the first relay is analyzed in greater detail.

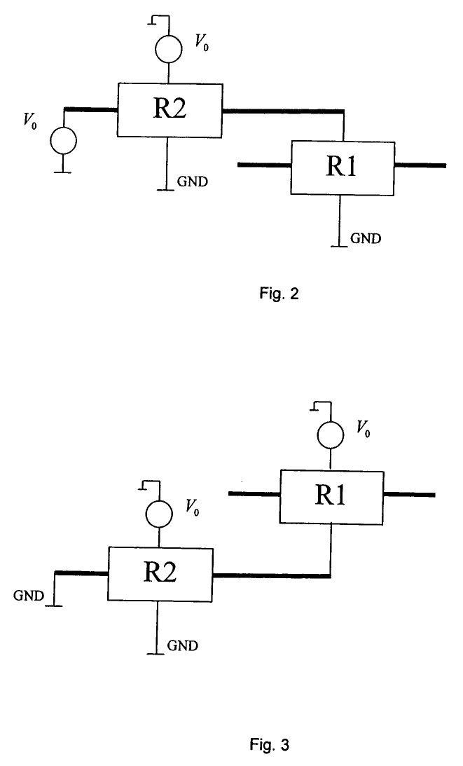

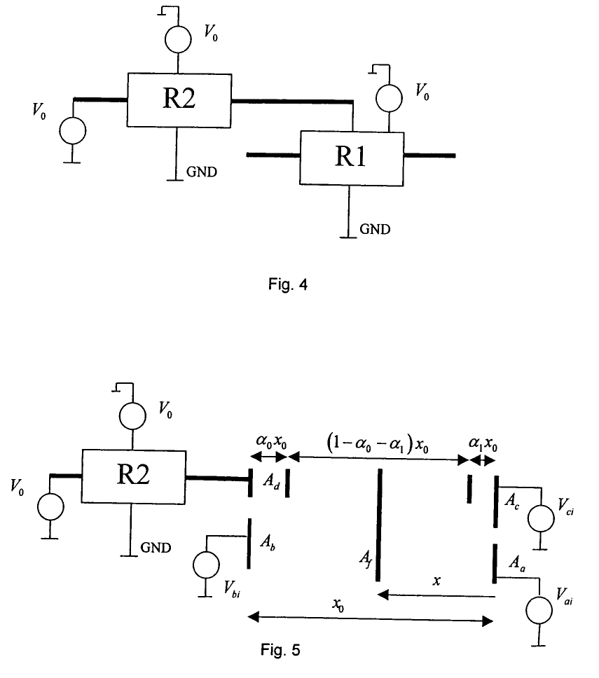

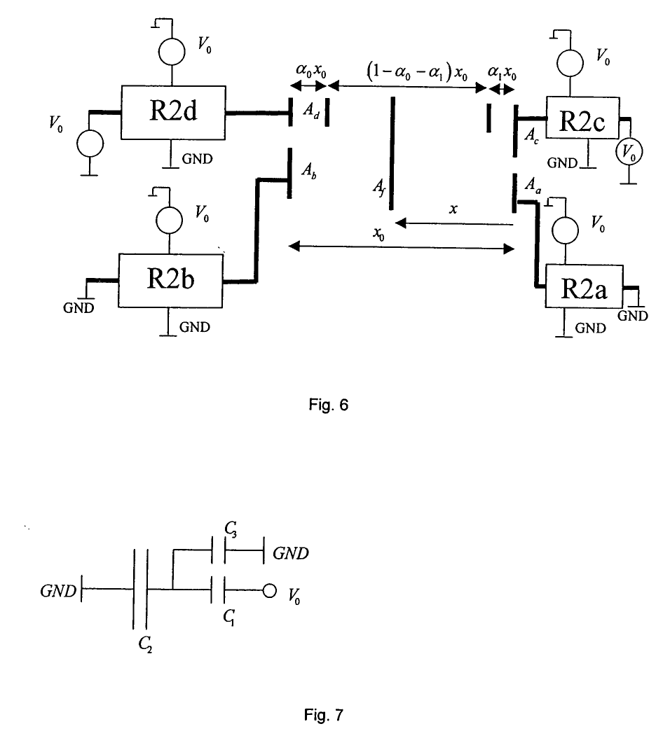

FIGS. 2 through 6 represent various connection layouts of two relays according to alternative 1. FIGS. 2 and 3 represent two basic layouts, in which the second relay R2 acts upon the plates of the first relay R1. Generally, the supply of R2 as well as the signal that R2 passes to R1 can be any. Also, generally, R1 may need an independent supply voltage to the one it receives from R2, this is shown in FIG. 4. FIG. 5 shows the details of R1 (see FIG. 1) and shows how R2 acts upon one of the condenser plates of R1, connecting it to V₀ or leaving it in a state of high impedance. Generally, the first relay R1 can have more than one condenser plate connected to a second relay R2. Also, generally, second relay R2 can be responsible for connecting the condenser plate to V₀ or to ground. FIG. 6 represents a preferred embodiment of the invention, wherein each of the plates of the first relay R1 is connected to a second relay R2, where each of the second relays is connected between V₀ and ground.

### Alternative 2

In the event that alternative 2 is chosen, the following relationships must be fulfilled:

$$\{ \begin{matrix}{C}_{A 3} = \frac{A}{{A}^{′}} {C}_{A 2} - 1 \\ {C}_{A 3}^{′} = \frac{{A}^{′}}{A} {C}_{A 2}^{′} - 1\end{matrix} \\ where \\ \{ \begin{matrix}A = {A}_{a} + {A}_{c} \\ {A}^{′} = {A}_{b} + {A}_{d}\end{matrix}$$

The analysis is detailed below considering that it is a SPST relay (Single Pole Single Throw, relay with a single conducting element (pole) and that it switches a single external circuit (throw)). A SPST relay is one that only has contact points of an external circuit at one end of the intermediate hollow space. Said SPST relay only acts upon a single external circuit. For their part, the SPDT relays (single pole double throw) have contact points on both sides of the intermediate hollow space (in other words, instead of the stoppers shown in FIG. 1, there are another two contact points of a second external circuit), whereby upon opening one external circuit the other external circuit closes.

In the following explanations it is going to be considered that the contact points are to the left of the conducting element, whereby the conducting element has to move to the left (towards the positive X values) to come into contact and electrically link the contact points, and it will have to move to the right (towards the negative X values) to separate the contact points, thus leaving the corresponding circuit open. However, logically, the conclusions drawn are independent of this geometrical consideration.

In order to guarantee that the miniaturized relay works correctly, it must be guaranteed that four different conditions are fulfilled:
the conducting element must be able to move from left to right along the intermediate hollow space, without being in contact with any contact point,
the conducting element must be able to move from right to left along the intermediate hollow space, also without being in contact with any contact point,
the conducting element must be able to separate from the contact points, by opening the circuit, which would correspond to starting to move from left to right,
the conducting element must be able to come into contact (and remain in this position) with the contact points in order to keep the circuit closed, which would correspond to ending the movement from right to left.

In the last two cases, the conducting element will be subject to a voltage that will be determined by the external circuit corresponding to the two contact points. In order to guarantee these four conditions, for an infinite range of conducting element voltages, in other words V_{S}ε(−∞, +∞), the following must be fulfilled:

$$\{ \begin{matrix}{C}_{A 2} < {{C}_{A 3} ( {α}_{0}^{- 1} - 1 )}^{- 2} + {[ {{C}_{A 3} ( {α}_{0}^{- 1} - 1 )}^{- 1} + {C}_{A 2} ]}^{2} \\ {C}_{A 3} > {( {α}_{0}^{- 1} - 1 )}^{2} {C}_{A 2} \\ {C}_{A 2}^{′} < {{C}_{A 3}^{′} ( {α}_{1}^{- 1} - 1 )}^{- 2} + {[ {{C}_{A 3}^{′} ( {α}_{1}^{- 1} - 1 )}^{- 1} + {C}_{A 2}^{′} ]}^{2} \\ {C}_{A 3}^{′} > {( {α}_{0}^{′ - 1} - 1 )}^{- 2} {C}_{A 2}^{′}\end{matrix}$$

Where α₀′ indicates the maximum distance that the free plate can separate from the electrical contact point still maintaining the contact and therefore the voltage of the external circuit, basically due to the plate bending, or curving if it is flexible, etc. Obviously the following will always be fulfilled:

α₀′>α₀

It can be proved that these equations cannot be satisfied together with the equations

$$\{ \begin{matrix}{C}_{A 3} = \frac{A}{{A}^{′}} {C}_{A 2} - 1 \\ {C}_{A 3}^{′} = \frac{{A}^{′}}{A} {C}_{A 2}^{′} - 1\end{matrix}$$

shown above.

The problem focuses on the relay opening and closing conditions. The relay opening will be analyzed in greater detail below. The relay closing condition can be analyzed in an equivalent manner.

For the relay opening condition the following inequation must be satisfied:

$$[ \frac{{A}_{2}}{{( {α}_{0}^{- 1} - 1 )}^{2}} - {A}_{1} - {A}_{3} ] \cdot {V}_{S}^{2} + [ 2 {A}_{1} {V}_{0} ] \cdot {V}_{S} + [ - {A}_{1} {V}_{0}^{2} ] < 0$$

This formula takes into account the fact that

Fₑ=F₂−F₁−F₃

in other words, the total electrostatic force is the sum of the force produced by each area A1, A2 and A3, as defined in Table 1, and each one is expressed as follows:

$$\{ \begin{matrix}{F}_{1} = \frac{ɛ}{2} {A}_{1} \cdot {( \frac{{V}_{0} - {V}_{S}}{x} )}^{2} \\ {F}_{2} = \frac{ɛ}{2} {A}_{2} \cdot {( \frac{{V}_{S}}{{x}_{0} - x} )}^{2} \\ {F}_{3} = \frac{ɛ}{2} {A}_{3} \cdot {( \frac{{V}_{S}}{x} )}^{2}\end{matrix}$$

It can be proved that when the conducting element is not in contact with the contact points of the external circuit, the equivalent electrical circuit is the one shown in FIG. 7

The following formula can be obtained for voltage V_{S}:

$${V}_{S} = \frac{\frac{{x}_{0}}{x} - 1}{( \frac{{x}_{0}}{x} - 1 ) \cdot ( {C}_{A 3} + 1 ) + {C}_{A 2}} \cdot {V}_{0}$$

The inequation

$$[ \frac{{A}_{2}}{{( {α}_{0}^{- 1} - 1 )}^{2}} - {A}_{1} - {A}_{3} ] \cdot {V}_{S}^{2} + [ 2 {A}_{1} {V}_{0} ] \cdot {V}_{S} + [ - {A}_{1} {V}_{0}^{2} ] < 0$$

cited above, defines a parabolic function in which the voltage of the conducting element, Vₛ, is the independent variable, in other words, Fₑ(V_{S}). By analyzing this function it can be seen that three situations can occur, which will depend on area coefficient values C_{Ai} and the value of α₀.

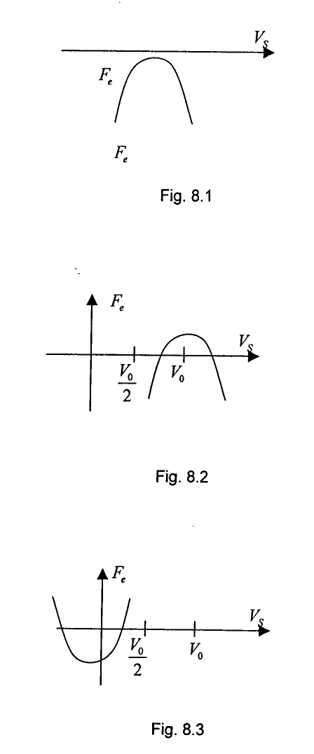

### Case 1: (see FIG. 8.1)

C_{A2}<C_{A3}(α₀⁻¹−1)⁻²

V_{S}ε(−∞,+∞)

### Case 2: (see FIG. 8.2)

$${{C}_{A 3} ( {α}_{0}^{- 1} - 1 )}^{- 2} < {C}_{A 2} < ( {C}_{A 3} + 1 ) {( {α}_{0}^{- 1} - 1 )}^{- 2}$$

$${V}_{S} ∈ ( - ∞ , \frac{{V}_{0}}{1 + \sqrt{{R}_{0}}} ) U ( \frac{{V}_{0}}{1 - \sqrt{{R}_{0}}} , + ∞ ) ⊃ ( - ∞ , \frac{{V}_{0}}{2} )$$

### Case 3: (see FIG. 8.3)

$${C}_{A 2} > ( {C}_{A 3} + 1 ) {( {α}_{0}^{- 1} - 1 )}^{- 2}$$

$${V}_{S} ∈ ( \frac{{V}_{0}}{1 - \sqrt{{R}_{0}}} , \frac{{V}_{0}}{1 + \sqrt{{R}_{0}}} ) ⋐ ( - ∞ , \frac{{V}_{0}}{2} )$$

The voltage range V_{S1} in case 1 includes voltage ranges V_{S2} and V_{S3} in cases 2 and 3, and the case 2 range includes the case 3 range, in other words

V_{S3}⊂V_{S2}⊂V_{S1}

where

R₀=C_{A2}(α₀⁻¹)²−C_{A3}

It is not possible to design a miniaturized SPST relay that works with alternative 2, in other words without any condenser plate in a state of high impedance, having simultaneously both the relay opening condition and the relay closing condition controlled by case 1. Therefore, in the case of alternative 2, it is not possible to guarantee that the miniaturized relay can open and close for any voltage Vₛ to which the conducting element is subjected.

It is necessary to combine the other options. In particular there are only two possibilities of real interest: making the two conditions (relay opening and closing) correspond to case 2, or making one of the conditions corresponds to case 1 and the other one to case 3. We will call these two possibilities, possibility 1 and possibility 2, respectively. Although there are other possibilities (where one of the conditions corresponds to case 2 and the other one to case 3, or where the two conditions correspond to case 3), they do not appear to have any practical interest.

### Possibility 1

In possibility 1, the two conditions correspond to case 2, whereby one of the following two voltage range intervals is obtained.

$${V}_{S} ∈ ( - ∞ , \frac{{V}_{0}}{2} )$$

$$or$$

$${V}_{S} ∈ ( \frac{{V}_{0}}{2} , + ∞ )$$

This solution can only be useful in particular cases, owing to the limitations that must be imposed with respect to V_{S}. In fact, the following must be fulfilled:

α₀′=α₀

which means a considerable practical limitation.

### Possibility 2

In possibility 2 one of the relay opening and closing conditions corresponds to case 1, which means that it is fulfilled for any V_{S}, but the other condition must correspond to case 3. Therefore the relay will be able to work with a V_{S} range that will be either smaller than

$$\frac{{V}_{0}}{2}$$

or larger than

$$\frac{{V}_{0}}{2}$$

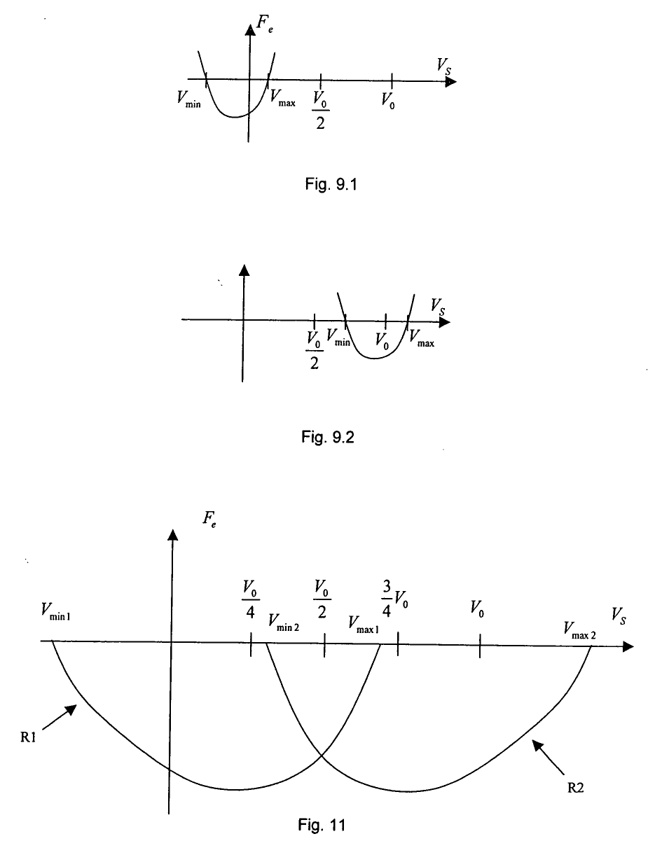

as shown in FIGS. 9.1 and 9.2. In order to obtain the range shown in FIG. 9.2 the polarity of the voltage applied to the condenser plates must be changed, in other words the relay must have inverted polarity.

Since the relay must guarantee that both conditions (opening and closing of the external circuit) are fulfilled simultaneously, the ranges in FIG. 9.1 or 9.2 are once again the relay's operational ranges and, as in possibility 1, they are only acceptable in certain circumstances, owing to the restrictions they impose with respect to V_{S}

The solution proponed by this invention for solving the problem of alternative 2 is to combine two miniaturized relays, each one of them working under different conditions, so that each of them has a range of permissible voltages V_{S} at least partially different. This allows the creation of a device that includes the combination of both miniaturized relays and has a range of permissible voltages V_{S} that is the combination of the voltage ranges of each relay. As it can be seen below, the two miniaturized relays could be combined by joining them serially or in parallel, depending on the desired result (really, depending on whether the relay in working in case 1 1 for the “open relay” condition or for the “close relay” condition). As will be mentioned below, the concept can be extended to more relays (serially connecting a plurality of relays, one plurality of relays in parallel and even one plurality of relays serially and in parallel) so that the device has a range that is the combination of all the relay ranges.

### Alternative 2.1:

A preferred embodiment of the invention is obtained when the second relay has at least one of its contact points connected to one of the contact points of the first relay (in other words, it is connected serially or in parallel to the first relay), and the control circuit acts upon the second relay by applying to at least one of the first, second, third and fourth condenser plates a third control signal and by applying to at least another of its first, second, third and fourth condenser plates a fourth control signal, where the fourth control signal is larger than the third control signal, whereby the second relay is activated with inverted polarity with respect to the first relay. None of the condenser plates of the relays remains in a state of high impedance.

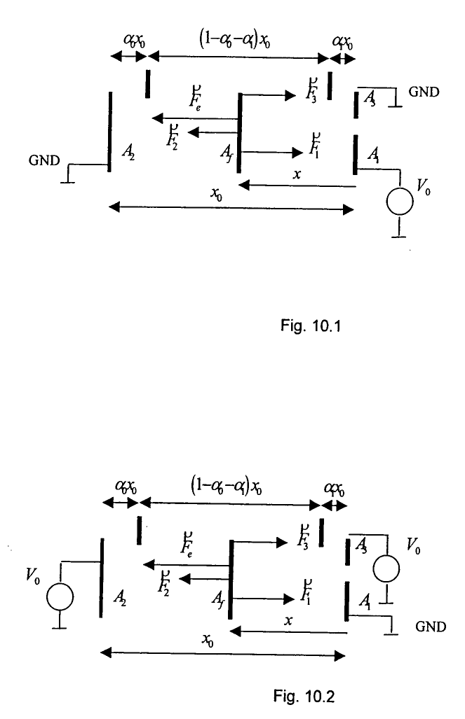

The relay has a very clear polarity definition when it is not activated in high impedance. On one side the two condenser plates are connected to one and the same voltage, and on the other side they are connected to different voltages. This means that in the end the layout is equivalent to the one shown in FIG. 10.1, where the two condenser plates to the left are equal to a single plate with an area equal to the sum of the areas of the two plates, because the two are connected to the same voltage, whereas on the right hand side the two condenser plates have different voltages. This way a polarity (+ for example) can be defined when the voltage applied to the two plates that are at the same voltage on one side is the smaller of the two control voltages, and the inverse polarity (−), when said voltage is greater. In the example in FIG. 10.1 above polarity would be (+). The inverse polarity (−) would be that shown in s FIG. 10.2.

### Alternative 2.2:

Another preferred embodiment of the invention is obtained when the second relay has at least one of its contact points connected to one of the contact points of the first relay, and the control circuit acts upon the second relay by applying to at least one of its first, second, third and fourth condenser plates a third control signal and by applying to at least another of its first, second, third and fourth condenser plates a fourth control signal, where the fourth control signal is smaller than the third control signal whereby the second relay is activated with the same polarity as the first relay, where at least one of the third and fourth control signals is different from the first and second control signal. None of the condenser plates of the relays remains in a state of high impedance. In this case, the second relay is made to work with other voltages, so that the operational range is different for both relays, although their polarity is not inverted.

Effectively, if miniaturized relays are used that guarantee the opening action for an infinite range of values V_{S} and the closing action for a finite range of values V_{S}, and if both relays are connected in parallel, the resulting device will have a range of operational values V_{S} that will be the combination of both ranges. If on the other hand, the miniaturized relays guarantee the closing action for an infinite range of values V_{S} and the opening action for a finite range of values V_{S}, its serial connection allows a device to be obtained having a range of operational values V_{S} that is the combination of both ranges. As stated above, this can be applied generally to combinations of a plurality of relays connected serially or in parallel. Generally, it can be said that the various ranges of values V_{S} for each miniaturized relay are obtained by making each of the miniaturized relays work under different conditions, in other words, by modifying their “V₀” and “0” values which, as stated above, do not only mean the supply and mass voltage but also “any voltage” and “any other voltage smaller than the preceding voltage”.

Preferably, in the case of alternative 2.1, the third control signal is equal to the second control signal and the fourth control signal is equal to the first control signal. Effectively, in this case there are two relays working in similar conditions but with inverted polarity. This solution allows the device to have a greater operational range than that of individual relays, although the range cannot include the average value between the first control signal and the third control signal. It is particularly advantageous that the second and third control signals are ground (0V) and that the first and fourth control signals are the supply voltage (V₀), since these two signals are always directly available in any circuit.

Another advantageous option, also in the case of alternative 2.1, is available when the second control signal is an intermediate signal between the first control signal and the third control signal, and the fourth control signal is an intermediate signal (generally different from the second control signal) between the first control signal and the third control signal. This way, it is possible to obtain an operational range that includes any value between 0V and the supply voltage, particularly the average value between the first and third control signals. The second relay is inverted with respect to the first relay and both relays are supplied by different voltage sources. It is particularly advantageous that the second control signal and the fourth control signal are equal to one another and, preferably, that they are the average value between the first control signal and the fourth control signal. This way only one intermediate voltage source is needed, since it supplies the second and fourth control signal simultaneously. Specifically, it is advantageous that the first control signal is the supply voltage (V₀), that the second and fourth control signals are equal to one another (and preferably are equal to V₀/2) and that the third control signal is the ground (0V).

Generally, using a second relay having inverted polarity with respect to the first relay allows a device to be provided having a operational Vₛ range between ground (0V) and the supply voltage (V₀) without any of the relays having to be activated with voltages lower than 0V or higher than V₀.

Some particular cases are described in detail below.

As already seen, generally it is desirable to have a device with an operational range that is greater than the operational range of each one of the relays making up said device. It is particularly advantageous that the range of permissible V_{S} includes from 0 to the value of the supply voltage (V₀ interpreted in its literal sense).

As also seen above, it is not possible to design a relay having a voltage range including V₀/2 by only using ground (0V) and V₀ as control voltages (in other words the voltages are applied to the relay condenser plates). One way of solving this problem is to use a double voltage source. A first relay can be controlled with voltages V₀ and V₀/2 and a second relay with voltages V₀/2 and ground. This way a device can be obtained having an operational range of 0V (ground) to V₀, including in particular V₀/2. FIG. 11 represents this graphically.

In this case, the voltage ranges V_{S1} and V_{S2} of the first and second relay are

$$\{ \begin{matrix}{V}_{S 1} = ( {V}_{min 1} , {V}_{max 1} ) \\ {V}_{S 2} = ( {V}_{min 2} , {V}_{max 2} )\end{matrix}$$

where it can be proved that

$$\{ \begin{matrix}{V}_{min 1} < 0 \\ \frac{{V}_{0}}{4} < {V}_{min 2} < \frac{{V}_{0}}{2} \\ \frac{{V}_{0}}{2} < {V}_{max 1} < \frac{3}{4} {V}_{0} \\ {V}_{max 2} > {V}_{0}\end{matrix}$$

and a design can be produced that fulfills

$$\{ \begin{matrix}{V}_{min 1} < 0 \\ \frac{{V}_{0}}{4} < {V}_{min 2} < \frac{{V}_{0}}{2} \\ \frac{{V}_{0}}{2} < {V}_{max 1} < \frac{3}{4} {V}_{0} \\ {V}_{max 2} > {V}_{0}\end{matrix}$$

This way, the following is obtained

Vₘᵢₙ₁<Vₘᵢₙ₂<Vₘₐₓ₁<Vₘₐₓ₂

Therefore

V_{S}=(Vₘᵢₙ₁,Vₘₐₓ₂)

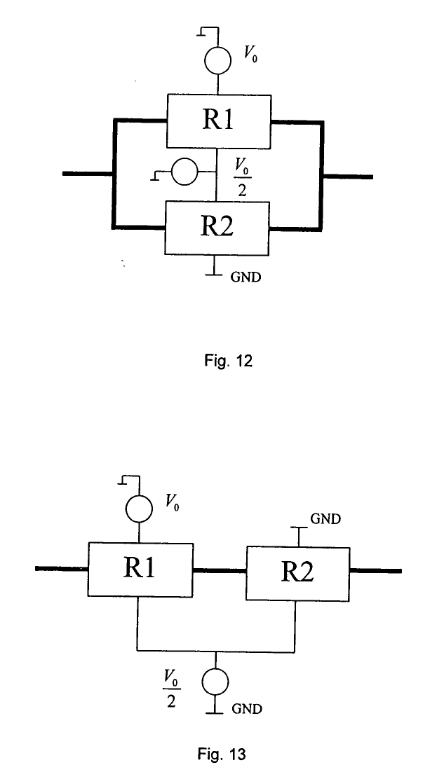

FIG. 12 represents a connection layout of the device according to the invention, with the two relays in parallel and supplied as indicated.

The values of the voltages applied are shown in Table 3. It can be seen that the second relay has its polarity inverted with respect to the first relay.

TABLE 3

| Status | Vₐ₁ | V_{b1} | V_{c1} | V_{d1} | Vₐ₂ | V_{b2} | V_{c2} | V_{d2} |
|---|---|---|---|---|---|---|---|---|
| Open | V₀ | $\frac{{V}_{0}}{2}$ | $\frac{{V}_{0}}{2}$ | $\frac{{V}_{0}}{2}$ | 0 | $\frac{{V}_{0}}{2}$ | $\frac{{V}_{0}}{2}$ | $\frac{{V}_{0}}{2}$ |
| Closed | $\frac{{V}_{0}}{2}$ | V₀ | $\frac{{V}_{0}}{2}$ | $\frac{{V}_{0}}{2}$ | $\frac{{V}_{0}}{2}$ | 0 | $\frac{{V}_{0}}{2}$ | $\frac{{V}_{0}}{2}$ |

Therefore, this is a way of obtaining a device that can guarantee working correctly (in other words, opening and closing the external circuit) for a V_{S} range that includes V₀/2. Also, with an appropriate relay design, the operational range can be made to include from 0 (understood as ground) to V₀ (understood as supply voltage).

The same strategy can be used as in the case above and apply it to the case in which two miniaturized relays are serially connected. In this case, the relays used would be designed to guarantee closing the external circuit under any V_{S} voltage applied to the conducting element and which have a finite operational range for opening the external circuit. In other words it is a question of combining case 1 and case 3 mentioned above, but with reference to the circuit closing condition.

By serially connecting both relays, the device assembly will have a voltage range V_{S} with which it will be able to guarantee opening the external circuit which range will be the combination of ranges V_{S1} and V_{S2} of the corresponding relays.

By using ground and V₀ as control voltages, it will not be possible to obtain a range of voltages V_{S} that includes V₀/2. One way of solving this problem is again by swing a double voltage source. The first relay is controlled with V₀ and V₀/2 and the second relay is controlled with V₀/2 and ground. This way a global operational range is obtained again that includes V₀/2. The graphical representation in FIG. 11 can be used again, taking into account that

$$\{ \begin{matrix}{V}_{S 1} = ( {V}_{min 1} , {V}_{max 1} ) \\ {V}_{S 2} = ( {V}_{min 2} , {V}_{max 2} )\end{matrix} \\ or \\ \{ \begin{matrix}{V}_{min 1} < \frac{{V}_{0}}{2} \\ \frac{{V}_{0}}{4} < {V}_{min 2} < \frac{{V}_{0}}{2} \\ \frac{{V}_{0}}{2} < {V}_{max 1} < \frac{3}{4} {V}_{0} \\ {V}_{max 2} > \frac{{V}_{0}}{2}\end{matrix}$$

and a design can be produced that fulfils

$$\{ \begin{matrix}{V}_{min 1} < 0 \\ \frac{{V}_{0}}{4} < {V}_{min 2} < \frac{{V}_{0}}{2} \\ \frac{{V}_{0}}{2} < {V}_{max 1} < \frac{3}{4} {V}_{0} \\ {V}_{max 2} > {V}_{0}\end{matrix}$$

Therefore the following is obtained

Vₘᵢₙ₁<Vₘᵢₙ₂<Vₘₐₓ₁<Vₘₐₓ₂

and

V_{S}=(Vₘᵢₙ₁,Vₘₐₓ₂)

FIG. 13 represents a connection layout of the device, with the two relays serially connected and the corresponding supply sources.

Table 4 shows the control voltages that must be applied to each condenser plate in order to open and close the device.

TABLE 4

| Status | Vₐ₁ | V_{b1} | V_{c1} | V_{d1} | Vₐ₂ | V_{b2} | V_{c2} | V_{d2} |
|---|---|---|---|---|---|---|---|---|
| Open | V₀ | $\frac{{V}_{0}}{2}$ | $\frac{{V}_{0}}{2}$ | $\frac{{V}_{0}}{2}$ | 0 | $\frac{{V}_{0}}{2}$ | $\frac{{V}_{0}}{2}$ | $\frac{{V}_{0}}{2}$ |
| Closed | $\frac{{V}_{0}}{2}$ | V₀ | $\frac{{V}_{0}}{2}$ | $\frac{{V}_{0}}{2}$ | $\frac{{V}_{0}}{2}$ | 0 | $\frac{{V}_{0}}{2}$ | $\frac{{V}_{0}}{2}$ |

Another preferred embodiment of the invention is obtained when the device has at least a third miniaturized relay, where the third relay is serially connected to the second relay if the second relay is serially connected to the first relay, or the third relay is connected in parallel to the second relay if the second relay is connected in parallel to the first relay. Effectively, in the event that it is not possible to cover the whole range 0V-V₀ with two relays (or it is not of interest, as it is easier to design relays with a smaller as opposed to a large range), then it is necessary to add more relays (all connected in the same way, in other words all serially connected or in parallel) so as to be able to cover the desired range. However, as stated above, often, when designing a relay, it is not always possible to know what the needed range will be. Therefore it may be of interest to have a device that has a plurality of relays which cover a particular range (preferably the whole range 0V-V₀) so that the device user can activate more or fewer relays according to particular needs.

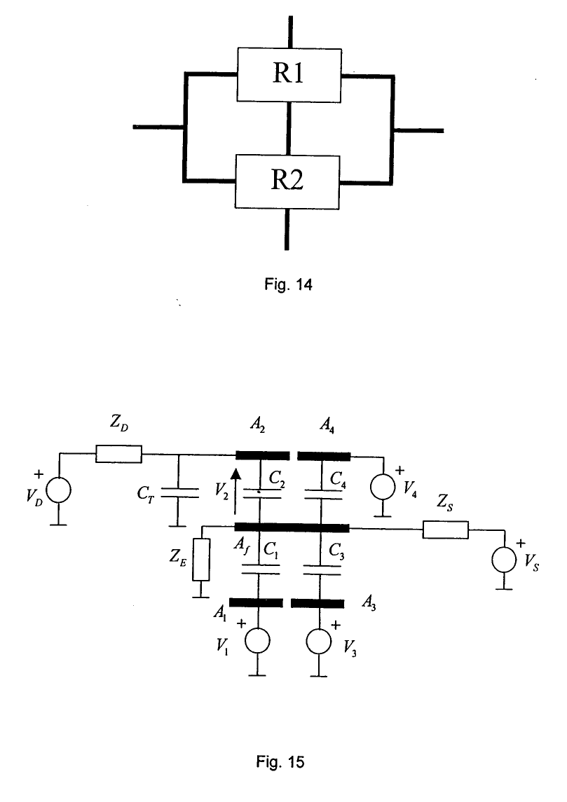

Another preferred embodiment of the invention is obtained when the device relays are SPDT relays, in other words, relays that act upon two external circuits simultaneously. As stated above, these relays have two pairs of electrical contacts, one on each side of the intermediate space, so that the relay opens one circuit when closing the other and vice versa. This way a device can be obtained that can also act upon two external electrical circuits simultaneously, opening one when closing the other. To do this, however, the following has to be taken into account: if the relays are working according to case 1 to open the first circuit (and, therefore, must be connected in parallel), then they will be working according to case 1 to close the second circuit, since when the first is opened the second one closes. Consequently, if they must be connected in parallel for one circuit, they must be serially connected for the other circuit. An example of this device is shown in FIG. 14.

Generally, in the layouts in the Figures, in which the relay has been illustrated as a rectangle, the external circuit connections have been shown in thick dotted lines, and the supply or control connections have been illustrated with a fine dotted line. Also, the two ends of one and the same external circuit are always drawn on opposite sides of the rectangle representing the relay.

### APPENDIX

### Alternative 1: Obtaining a State of High Impedance in a Condenser Plate of the First Relay

As stated above, a preferred embodiment of the invention is obtained when the state of high impedance of certain condenser plates of the first miniaturized relay is guaranteed. To do this each of the condenser plates in question has been connected to a second relay (so that there are as many second relays as there are condenser plates for the first relay (for example, 4)), which will be responsible for connecting the plate to a previously determined voltage (V₀ or 0). Then the effectiveness of this embodiment will be proved. This analysis will be divided into two different cases: when conducting element A_{f} of the first relay is closing the external circuit of the first relay and, therefore, is subjected to a voltage V_{f} obliged by the external circuit of the first relay, or when the conducting element of the first relay is moving freely along the space inside the first relay, in which case its voltage V_{f} is determined by the voltage of the four condenser plates of the first relay. In order to simplify the nomenclature, it will be considered that the first relay has 4 condenser plates (A₁, A₂, A₃, and A₄) with four capacities (C₁, C₂, C₃, and C₄) and that the condenser plate that has to obtain the state of high impedance is plate A₂. Logically these results can be applied generally to any condenser plate.

### a) Closed External Circuit

Plate A₂ is controlled by a control circuit, or voltage source, that is suitable for supplying voltage V_{D} to the plate. The voltage source has an output impedance Z_{D}. The external circuit of the first relay is represented as a voltage source having value V_{S} and impedance Z_{S} on one side of the conducting element and impedance Z_{E} to ground on the other side. C_{T} is the capacity of the connection track. FIG. 15 shows the corresponding electrical layout. This layout can be simplified if it is considered that, in order to minimize influence in the closed external circuit, the following design requirement must be applied:

Z_{S}<<Z_{Ci}

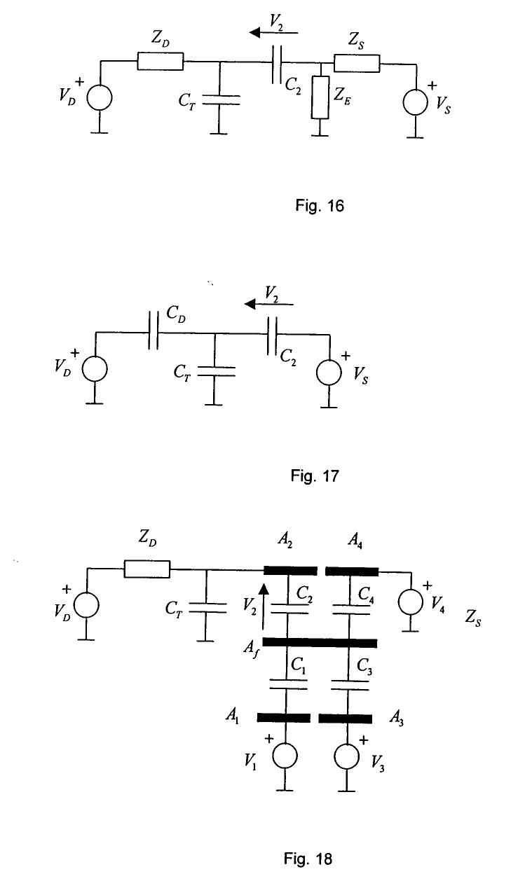

Taking into account this condition, the simplified electrical circuit corresponds to the one shown in FIG. 16.

The high impedance condition means that there is practically no voltage drop in C₂, in other words that V₂ is virtually 0. This has to be reached irrespective of the values Z_{S} and V_{S}. In particular this has to be satisfied when Z_{S}=0. However, given that V₂ is the voltage in terminals with one capacity, said voltage has infinite impedance and, therefore, the voltage divider made with C₂ and Z_{D}∥C_{T} will make all the voltage drop via C₂, unless impedance Z_{D} is made with a capacitive component C_{D}. Therefore this is a necessary requirement for being able to reach a state of high impedance. In this case the circuit is simplified even further, and corresponds to the one shown in FIG. 17.

In the circuit in FIG. 17 the following must be fulfilled

$${V}_{2} = {V}_{D} \frac{{C}_{D}}{{C}_{D} + {C}_{2} + {C}_{T}} - {V}_{S} \frac{{C}_{D} + {C}_{T}}{{C}_{D} + {C}_{2} + {C}_{T}}$$

since V_{S} cannot be controlled, the following sufficient condition must be obliged

C_{D}<<C₂+C_{T}

C^{D}+C_{T}<<C₂

the first inequation is equivalent to

C₂>>C_{D}+C_{T}−2C_{T}

which is satisfied in any event if the second inequation is fulfilled. Therefore the second inequation is a sufficient condition for both, and can be expressed in the following way:

C₂>>C_{D}+C_{T}

If Z_{S} is different from 0, this is a sufficient condition. And since the value V_{S} cannot be controlled, this condition is also necessary. In other words the condition that must be fulfilled to reach a state of high impedance is that the output capacity of the voltage source plus the capacity of the track has to be less than the capacity of plate A₂.

### b) Open External Circuit

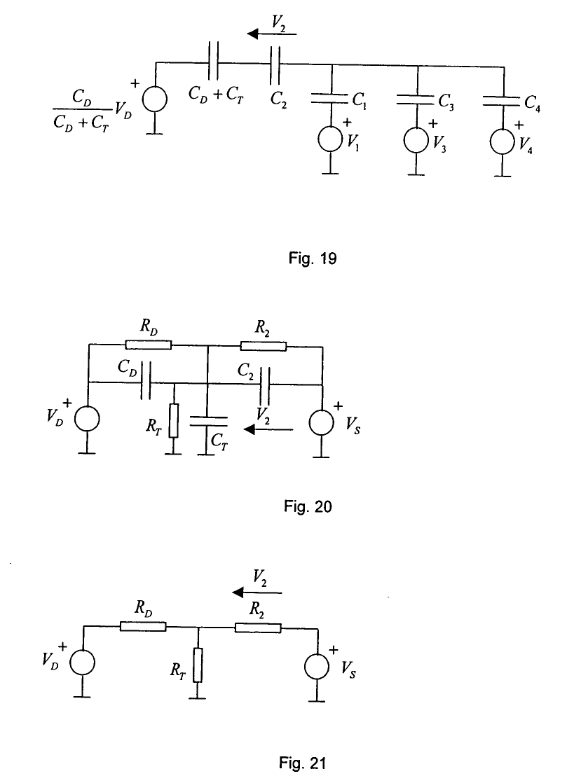

In the event that the external circuit is open, there is no external voltage V_{S} connected to the conducting element of the first relay. In this case the corresponding electrical layout is the one shown in FIG. 18. The design requirements necessary in the case of the closed external circuit must also be applied in this case, since the voltage source will be the same in both cases, and so the voltage source will have to have a capacitive impedance, whereby the equivalent electrical circuit is the one shown in FIG. 19.

It is observed that the sufficient condition

C₂>>C_{D}+C_{T}

Indicated above is also a sufficient condition for the circuit in FIG. 19, since one again we have a voltage divider made up of C₂ and C_{D}+C_{T}. Also, it can be seen that this condition is also sufficient for other more complex activation layouts, in which more condenser plates need to be placed in a state of high impedance.

### c) Substrate Resistances

In sections a) and b) above the spray currents from the condensers owing to their parallel parasitic resistances have not been taken into account. These resistances go from one end of each condenser to ground (in other words the substrate of the integrated circuit in which the device is located). These resistances have very high values, and therefore usually they can be rejected, but since the device is operating with pure capacitive impedances, these resistances must be taken into account. Generally, in short periods of time the capacitive impedances will dominate, but in longer periods of time (depending on the corresponding time constant) these parallel resistances will become dominant, as they are in parallel with infinite impedances. In the particular case of the device according to the invention, the fact should not be ignored that the first relay may be required to remain in a particular state (open or closed) during a long, a priori determined, period of time. Therefore it is advisable to guarantee that the device can operate under these conditions.

FIG. 20 shows the corresponding electrical circuit when these parallel resistances are taken into account, represented as R_{D}, R_{T} and R₂. When analyzing the behavior of each circuit after a long period of time, these resistances will become dominant, because the condensers will behave like open circuits (in the direct current zone). Therefore the corresponding electrical circuit will be the one shown in FIG. 21. As it can be seen this circuit is equivalent to the circuit shown in FIG. 17, in which condensers C_{D}, C_{T} and C₂ have been replaced with resistances R_{D}, R_{T} and R₂. In order to minimize V₂ it must be satisfied that

R₂<<R_{D}∥R_{T}

or, equivalently

R₂<<R_{D}

R₂<<R_{T}

In other words, R₂ has to be much smaller than R_{D} and R_{T}.

It is important to take into account that the substrate resistance R₁ will only exist when the conducting element is touching some of the fixed parts of the device, since while the conducting element is in the air (supposing that it does not reach the air breakdown voltage) there is no leakage current. In other words, when the conducting element is moving, R₂ is infinite. In this condition the following are not fulfilled

R₂<<R_{D}

R₂<<R_{T}

Therefore it must be guaranteed that during the switching time tₛ condensers C_{D} and C_{T} dominate over their corresponding substrate resistances R_{D} and R_{T}, in other words,

R_{D}C_{D}>>tₛ

R_{T}C_{T}>>tₛ

Therefore, in order to satisfy these conditions and, at the same time conditions

R₂<<R_{D}

R₂<<R_{T}

very high values are needed for R_{D} and R_{T}.

### d) Design of the Device

One way of ensuring that this relationship is obtained

C₂>>C_{D}+C_{T}

is as follows. The second relay has two contact points that, really, will be surfaces on which the conducting element will be supported for closing the external circuit (which is the circuit controlling the voltage that is applied to the condenser plate of the first relay which it is desirable to be able to leave in a state of high impedance, that is, plate A₂). Since it must be fulfilled that the output capacity of the voltage source (that is, of the second relay in open state) plus the capacity of the connection track has to be less than the capacity of plate A₂, and taking into account that usually the first relay and the second relay will be in one and the same chip and have been manufactured using the same technology and have similar thicknesses, it must be fulfilled that area A_{S} of the contact points of the second relay (of all of them) must be less than A₂ of the condenser plate of the first relay which we want to be able to leave in a state of high impedance.

A_{S}<<Aᵢ

Usually the contact points will be a minimum size, whereby this condition could easily be satisfied.

e) Optimized Design of a Device Having a First Relay with Four Condenser Plates and Two Second Relays

Generally, a second relay is needed for each condenser plate in the first relay that we want to put in a state of high impedance. In other words, if we suppose that the first relay has four condenser plates (although it could have more plates) then four second relays are needed. This means increasing the integrated circuit area needed for the complete device. Below it is shown how, in certain cases, a first relay can be controlled with four condenser plates using just two second relays.

For example, if we suppose that a first relay has four condenser plates and a symmetrical design having C_{A2}=0 y C_{A3}=1, then the conditions that must be imposed on the condenser plates so as to be able to activate the relay are shown in Table 5

TABLE 5

| Status | V₁ | V₂ | V₃ | V₄ |
|---|---|---|---|---|
| Right | V₀ | Z | GND | Z |
| Left | Z | V₀ | Z | GND |

This combination of voltages can be supplied to the condenser plates of the first relay using just two second relays, if the two second relays are of the SPDT type, in other words, relays that act on two external circuits simultaneously, as stated above. The first of the second SPDT relays has its first external circuit connected to condenser plate A₁ (in other words the one at voltage V₁) and its second external circuit connected to condenser plate A₂ (in other words the one at voltage V₂). At the opposite end both circuits are connected to V₀. This way, when the first of the second SPDT relays closes the external circuit corresponding to A₁, V₁ is V₀ and the external circuit corresponding to A₂ remains open, whereby it remains in a state of high impedance. Similarly the second of the second SPDT relays, has its first external circuit connected to condenser plate A₃ (in other words the one at voltage V₃) and its second external circuit connected to condenser plate A₄ (in other words the one at voltage V₄). At the opposite end both external circuits are connected to ground (GND). When the second of the second SPDT relays closes the external circuit corresponding to A₃, V₃ is GND and A₄ remains in a state of high impedance, and when the external circuit corresponding to A₄, V₄ is GND and A₃ remains in a state of high impedance.

For its part, the firing voltages of these two second SPDT relays are shown in Table 6.

TABLE 6

| Status | V₁ | V₂ | V₃ | V₄ |
|---|---|---|---|---|
| Right | V₀ | GND | GND | GND |
| Left | GND | V₀ | GND | GND |

1-9. (canceled)

10. Device for connecting two points in an electrical circuit, which comprises:
a first miniaturized relay having an intermediate hollow space defining a first end and a second end, which is opposite said first end, a conducting element housed inside said intermediate space and movable between said first end and said second end, a first condenser plate and a second condenser plate arranged next to said first end, a third condenser plate and a fourth condenser plate arranged next to said second end and opposite said first condenser plate and second condenser plate where said conducting element moves between said first end and said second end according to electrical signals applied to said condenser plates, two contact points, where said conducting element can contact said contact points to join them electrically;
a control circuit which applies to at least one of said first, second, third and fourth condenser plates a first control signal, and applies to at least another of said first, second, third and fourth condenser plates a second control signal that is smaller than said first control signal,
a second miniaturized relay including an intermediate hollow space defining a first end and a second end, which is opposite said first end, a conducting element housed inside said intermediate space and which is movable between said first end and said second end, a first condenser plate and a second condenser plate arranged next to said first end, a third condenser plate and a fourth condenser plate arranged next to said second end and opposite said first condenser plate and second condenser plate, where said conducting element moves between said first end and said second end according to electrical signals applied to said condenser plates, two contact points, where said conducting element can contact said contact points to join them electrically,
wherein either said second relay has one of its contact points connected to one of said first, second, third and fourth condenser plates of said first miniaturized relay, whereby when said second miniaturized relay is open, said condenser plate of said first miniaturized relay that is electrically connected to said contact points of said second miniaturized relay remains in a state of high impedance;
or said second miniaturized relay has at least one of its contact points connected to one of the contact points of said first miniaturized relay, and said control circuit applies to at least one of said first, second, third and fourth condenser plates of the second miniaturized relay a third control signal and applies to at least another of said first, second, third and fourth condenser plates of the second miniaturized relay a fourth control signal that is larger than said third control signal, whereby said second relay is activated with its polarity inverted with respect to said first miniaturized relay, where none of said first, second, third and fourth condenser plates of none of said first and second miniaturized relays remain in a state of high impedance,
or said second miniaturized relay has at least one of its contact points connected to one of the contact points of said first miniaturized relay, and said control circuit applies to at least one of said first, second, third and fourth condenser plates of said second miniaturized relay a third control signal and applies to at least another of said first, second, third and fourth condenser plates of said second relay a fourth control signal that is smaller than said third control signal whereby the second relay is activated with the same polarity as the first relay, where at least one of said third and fourth control signals is different from said first control signal and said second control signal, where none of said first, second, third and fourth condenser plates of none of said first and second miniaturized relays remains in a state of high impedance.

11. Device according to claim 1, wherein said second miniaturized relay has at least one of its contact points connected to one of the contact points of said first miniaturized relay, wherein said second relay is activated with its polarity inverted with respect to said first miniaturized relay, and wherein said third control signal is equal to said second control signal, and said fourth control signal is equal to said first control signal.

12. Device according to claim 1, wherein said second miniaturized relay has at least one of its contact points connected to one of the contact points of said first miniaturized relay, wherein said second relay is activated with its polarity inverted with respect to said first miniaturized relay, and wherein said second control signal is an intermediate signal between said first control signal and said third control signal, and said fourth control signal is an intermediate signal between said first control signal and said third control signal.

13. Device according to claim 3, wherein said second control signal and said fourth control signal are equal to one another and are an average value between said first control signal and said third control signal.

14. Device according to claim 10 further comprising, at least a third miniaturized relay including an intermediate hollow space defining a first end and a second end, which is opposite said first end, a conducting element housed inside said intermediate space and which is movable between said first end and said second end, a first condenser plate and a second condenser plate arranged next to said first end, a third condenser plate and a fourth condenser plate arranged next to said second end and opposite said first condenser plate and second condenser plate, where said conducting element moves between said first end and said second end according to electrical signals applied to said condenser plates, two contact points, where said conducting element can contact with said contact points joining them electrically; and where said third relay is serially connected to said second relay if said second relay is serially connected to said first relay, or said third relay is connected in parallel to said second relay if said second relay is connected in parallel to said first relay.

15. Device according to claim 11 further comprising, at least a third miniaturized relay including an intermediate hollow space defining a first end and a second end, which is opposite said first end, a conducting element housed inside said intermediate space and which is movable between said first end and said second end, a first condenser plate and a second condenser plate arranged next to said first end, a third condenser plate and a fourth condenser plate arranged next to said second end and opposite said first condenser plate and second condenser plate, where said conducting element moves between said first end and said second end according to electrical signals applied to said condenser plates, two contact points, where said conducting element can contact with said contact points joining them electrically; and where said third relay is serially connected to said second relay if said second relay is serially connected to said first relay, or said third relay is connected in parallel to said second relay if said second relay is connected in parallel to said first relay.

16. Device according to claim 12 further comprising, at least a third miniaturized relay including an intermediate hollow space defining a first end and a second end, which is opposite said first end, a conducting element housed inside said intermediate space and which is movable between said first end and said second end, a first condenser plate and a second condenser plate arranged next to said first end, a third condenser plate and a fourth condenser plate arranged next to said second end and opposite said first condenser plate and second condenser plate, where said conducting element moves between said first end and said second end according to electrical signals applied to said condenser plates, two contact points, where said conducting element can contact with said contact points joining them electrically; and where said third relay is serially connected to said second relay if said second relay is serially connected to said first relay, or said third relay is connected in parallel to said second relay if said second relay is connected in parallel to said first relay.

17. Device according to claim 13 further comprising, at least a third miniaturized relay including an intermediate hollow space defining a first end and a second end, which is opposite said first end, a conducting element housed inside said intermediate space and which is movable between said first end and said second end, a first condenser plate and a second condenser plate arranged next to said first end, a third condenser plate and a fourth condenser plate arranged next to said second end and opposite said first condenser plate and second condenser plate, where said conducting element moves between said first end and said second end according to electrical signals applied to said condenser plates, two contact points, where said conducting element can contact with said contact points joining them electrically; and where said third relay is serially connected to said second relay if said second relay is serially connected to said first relay, or said third relay is connected in parallel to said second relay if said second relay is connected in parallel to said first relay.

18. Device according to claim 1, wherein each miniaturized relay has two additional contact points for connecting a second electrical circuit, and
wherein that said relays are serially connected from the point of view of the electrical circuit and are connected in parallel from the point of view of a second electrical circuit.

19. Device according to claim 1, where said second miniaturized relay has one of its contact points connected to one of said first, second, third and fourth condenser plates of said first miniaturized relay via a connection track,
wherein an output capacity of said second miniaturized relay plus the capacity of said connection track is smaller that a capacity of said condenser plate of said first miniaturized relay.

20. Device according to claim 7, wherein the contact points of said second miniaturized relay has, in total, a smaller surface than the surface of said condenser plate of said first miniaturized relay.

21. Device according to claim 1, wherein said second relay has at least one of its contact points connected to one of said first, second, third and fourth condenser plates of said first miniaturized relay, and further comprising two of said second relays, where each of said second relays has two pairs of contact points with each of said pairs being at one end of the intermediate space so that each of the second relays is an single pole single throw relay, where one contact point in each pair is electrically connected to one of said first, second, third and fourth condenser plates of said first miniaturized relay and the other contact point in each pair is electrically connected together.
